(19) United States
(12) Patent Application Publication
(10) Pub. No.: US 2023/0228540 A1
(43) Pub. Date: Jul. 20, 2023

(54) SYSTEM AND METHOD FOR A SMART RAIL TARGET

(71) Applicant: MILO Range, Ann Arbor, MI (US)

(72) Inventors: Russell Gries, Las Vegas, NV (US); Jake Cook, Las Vegas, NV (US)

(73) Assignee: MILO Range, Ann Arbor, MI (US)

(21) Appl. No.: 18/155,472

(22) Filed: Jan. 17, 2023

Related U.S. Application Data
(60) Provisional application No. 63/300,201, filed on Jan. 17, 2022.

(51) Int. Cl. F41J 9/02; F41J 1/10; F41J 11/00

(52) U.S. Cl. CPC F41J 9/02; F41J 1/10; F41J 11/00

(57) ABSTRACT

A system for a smart rail target is provided. The system includes a metal rail and a car device. The car device is configured for being mounted to and moving along the metal rail. The car device includes a plurality of traction wheels configured for moving the car device along the metal rail, an electric motor configured for providing motive force to the traction wheels, and a rechargeable energy storage device configured for providing electrical energy to the electric motor. The system further includes a lane controller charging station connected to the metal rail and including a charging transmitter configured for charging the rechargeable energy storage device when the car device abuts the lane controller charging station.

### CROSS-REFERENCE TO RELATED APPLICATIONS

This disclosure claims priority to Provisional Patent Application No. 63/300,201 filed on Jan. 17, 2022, which is hereby incorporated by reference.

### INTRODUCTION

The disclosure generally relates to a system and method for a smart rail target.

A gun range is a facility where one may go to practice target shooting. A gun range may feature live firing of firearms. Alternatively, a gun range may feature simulated firing of firearms. Gun ranges may have high levels of technology, with computerized systems providing simulations and various features to aid in training of various situations, for example, including complicated law enforcement and self-defense situations. Gun ranges may include a simple electrically powered rail system, where a shooter may move a target from an initial point at the shooter's station some distance downrange, and then later move the target back to the initial point.

### SUMMARY

A system for a smart rail target is provided. The system includes a metal rail and a car device. The car device is configured for being mounted to and moving along the metal rail. The car device includes a plurality of traction wheels configured for moving the car device along the metal rail, an electric motor configured for providing motive force to the traction wheels, and a rechargeable energy storage device configured for providing electrical energy to the electric motor. The system further includes a lane controller charging station connected to the metal rail and including a charging transmitter configured for charging the rechargeable energy storage device when the car device abuts the lane controller charging station.

In some embodiments, the charging transmitter includes a first metal coil configured for creating a magnetic field. The car device includes a charging portion including a second metal coil configured for using the magnetic field to create an electric current useful for recharging the rechargeable energy storage device.

In some embodiments, the lane controller charging station further includes a mechanical stop configured for providing a proper location for the car device to stop to be recharged.

In some embodiments, the car device further includes a mounting feature configured for suspending a shooting range target and controlling rotation of the shooting range target.

In some embodiments, the electric motor includes a first electric motor configured for providing a first motive force to a first portion of the plurality of traction wheels. The car device further includes a second electric motor configured for providing a second motive force to a second portion of the plurality of traction wheels.

In some embodiments, the car device further includes a computerized car device controller controlling operation of the car device.

In some embodiments, the computerized car device controller is in wireless communication with the lane controller charging station.

In some embodiments, the system further includes a computerized rangemaster controller in wireless communication with the computerized car device controller and providing computerized control to a local rangemaster.

In some embodiments, the system further includes a remote computerized server device in wireless communication with the computerized car device controller and providing access to a plurality of computerized range simulations.

In some embodiments, the lane controller charging station further includes a lane indicator facia including one of a backlit lane indication, a backlight with a selectable color, or a computerized display.

According to one alternative embodiment, a system for a smart rail target is provided. The system includes a metal rail and a car device configured for being mounted to and moving along the metal rail. The car device includes a plurality of traction wheels configured for moving the car device along the metal rail and an electric motor configured for providing motive force to the traction wheels. The car device further includes a rechargeable energy storage device configured for providing electrical energy to the electric motor. The car device further includes a mounting feature configured for suspending a shooting range target and controlling rotation of the shooting range target and a computerized car device controller controlling operation of the car device. The system further includes a lane controller charging station connected to the metal rail. The lane controller charging station includes a charging transmitter configured for charging the rechargeable energy storage device when the car device abuts the lane controller charging station. The system further includes a shooting stall configured for a user to occupy during operation a computerized range simulation and a computerized control panel disposed upon the shooting stall and configured for enabling the user to control the operation of the computerized range simulation.

In some embodiments, the charging transmitter includes a first metal coil configured for creating a magnetic field. The car device includes a charging portion including a second metal coil configured for using the magnetic field to create an electric current useful for recharging the rechargeable energy storage device.

In some embodiments, the computerized car device controller is in wireless communication with the lane controller charging station.

In some embodiments, the system further includes a computerized rangemaster controller in wireless communication with the computerized car device controller and providing computerized control to a local rangemaster.

In some embodiments, the computerized rangemaster controller includes programming to provide shot scoring to the user.

In some embodiments, the computerized rangemaster controller includes programming to provide a virtual instructor feature to the user.

In some embodiments, the system further includes a remote computerized server device in wireless communication with the computerized car device controller and providing access to a plurality of candidate computerized range simulations.

According to one alternative embodiment, a method for a smart rail target is provided. The method includes, within a lane of a gun range, suspending a metal rail and mounting a car device to the metal rail. The car device includes a rechargeable energy storage device and is configured for moving forward or backward along the metal rail. The car device is further configured for suspending a shooting range target. The method further includes mounting a lane controller charging station to a first end of the metal rail. The lane controller charging station includes a charging transmitter configured for wirelessly charging the car device. The method further includes, when the rechargeable energy storage device has a low state of charge, moving the car device to the first end of the metal rail and wirelessly charging the car device.

In some embodiments, the method further includes, within a computerized processor, operating a computerized range simulation configured for selectively controlling the car device.

In some embodiments, selectively controlling the car device includes controlling movement of the car device along the metal rail and controlling rotation of the shooting range target.

According to one alternative embodiment, a method for a smart rail target is provided. The method includes within a lane of a gun range, suspending a metal rail and mounting a car device to the metal rail. The car device includes a rechargeable energy storage device and is configured for moving forward or backward along the metal rail and is further configured for suspending a shooting range target. The method further includes mounting a lane controller charging station to a first end of the metal rail. The lane controller charging station includes a charging transmitter configured for wirelessly charging the car device. The method further includes, when the energy storage device has a low state of charge, moving the car device to the first end of the metal rail and wirelessly charging the car device.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary system for a smart rail target, in accordance with the present disclosure;

FIG. 2 schematically illustrates the lane controller docking station of FIG. 1, in accordance with the present disclosure;

FIG. 3 schematically illustrates a portion of the metal track of FIG. 1, in accordance with the present disclosure;

FIG. 4 schematically illustrates the car device of FIG. 1 in side view, in accordance with the present disclosure;

FIG. 5 schematically illustrates the computerized car device controller of FIG. 4, in accordance with the present disclosure;

FIG. 6 schematically illustrates the car device of FIG. 1 in front view, with a shooting range target attached to the car device, in accordance with the present disclosure;

FIG. 7 schematically illustrates the car device of FIG. 6 in front view, with the target turned to face a user/shooter, in accordance with the present disclosure;

FIGS. 8-10 schematically illustrate the system of FIG. 1 in a docked state, a traveling downrange state, and a returning to be charged state, respectively, in accordance with the present disclosure;

FIGS. 11-14 schematically illustrate one exemplary alternative embodiment of a lane controller charging station including a charging transmitter, in accordance with the present disclosure;

FIG. 15 schematically illustrates a portion of a metal track, in accordance with the present disclosure;

FIG. 16 schematically illustrates a shooting stall, including the lane controller charging station, the metal rail, a car device, and a computerized control panel, in accordance with the present disclosure;

FIG. 17 schematically illustrates the car device upon the metal track abutting the lane controller charging station, with charging portion located within a charging distance of a charging transmitter, in accordance with the present disclosure;

FIG. 18 schematically illustrates in cutaway perspective view the car device upon the metal track abutting the lane controller charging station, in accordance with the present disclosure;

FIG. 19 is a flowchart illustrating a method for a smart rail target, in accordance with the present disclosure;

FIG. 20 schematically illustrates an exemplary gun range including a first lane controller charging station, a second lane controller charging station, and a third lane controller charging station, in accordance with the present disclosure.

### DETAILED DESCRIPTION

Gun range equipment is available in different configurations. One may define a common rail target system as an inexpensive configuration used in most retail gun ranges. A common rail target system may include a metal rail, a control panel, and a common car device that suspends a target in a single orientation and is configured to move down the metal rail. The common car device may be a traveling bracket with no features other than enabling movement of the target forward and backward upon the metal rail.

One may define a smart rail target system as including a metal rail, one or more computerized control panels, and a car device with equipment providing computerized features therethrough. Computerized features of the car device may include but are not limited to selectively turning a shooting range target 360 degrees/toward and away from a shooter, selectively illuminating the target with light, electronically scoring shots by the shooter upon the target, emitting sounds, recording sounds, coordinating computerized control with a multimedia training program, and/or other similar features.

A system and method for a smart rail target is provided. The system may include a metal rail, a computerized control panel, a car device including an on-board energy storage device useful to provide electrical energy for motive force and/or computerized features to the car device, and a lane controller docking station including a wireless charging transmitter useful to charge the energy storage device of the car device wirelessly.

In one embodiment, the disclosed system may be a wireless, live fire target system for use on common target rail systems in modular and brick and mortar shooting ranges. A single, modular car device providing a target is provided and supports multiple optional features.

In one embodiment, the system provides a single, modular, wireless car device or target carrier that supports feature add-ons post-installation of a common metal rail system. The disclosed system may be utilized to temporarily retrofit a common rail target system for increased functionality. For example, a retail gun range operating on a tight budget may include a common metal rail system that was purchased as a lowest cost available system, enabling a user to mount a paper target upon a static car device, move the paper target downrange, conduct target practice, and move the paper target back to an initial position to retrieve the target. A local police department may approach the owner of the retail gun range and provide funding for an upgrade which would give local police enhanced training opportunities. Such an offer to provide funding may include retrofitting one of the lanes in the retail gun range with the disclosed system. Such an offer to provide funding may alternatively include renting the disclosed system for a weekend to host a special event for training the local police, with the disclosed system being installed to one or more lanes for the weekend and then later being uninstalled for return to a rental company.

The disclosed system includes a car device including an on-board energy storage device which may be embodied as a battery or a plurality of batteries. The energy storage device is rechargeable, such that when the energy storage device is depleted of electrical energy, the energy storage device may be supplied with electrical energy to restore a state of charge of the energy storage device.

The disclosed system includes a lane controller docking station that is configured for wirelessly charging and recharging the car device. Inductive charging or electromagnetic induction may be used to wirelessly induce electric current that may be utilized to charge an energy storage device. In one embodiment, a transmitting unit, for example, on the lane controller docking station, includes a first set of wire coils, through which alternating current is run. This alternating current in the wire coils of the transmitting unit creates a magnetic field. A receiving unit, for example, upon the car device, includes a second set of wire coils. The magnetic field created by the first set of wire coils induces or creates an alternating current in the second set of wire coils. Thus, electrical energy in a first device may be utilized to wirelessly induce electrical energy in a second device.

The disclosed system utilizes wireless charging to charge and recharge the energy storage device of the car device. This wireless charging includes excellent reliability. An alternative configuration may include a direct coupling of the car device to a charging station. Gun ranges are inherently not clean environments. Discharging firearms propels gunpowder residue into the air around the shooter. This residue and other dust may quickly contaminate and prevent clean contact between exposed electrical contacts of a car device and corresponding charger station. Wireless charging avoids reliability issues caused by gunpowder residue, enabling the rechargeable energy storage device to be recharged in spite of contaminants in the air and on surfaces around a shooting station.

A plurality of computerized control panels or modules may be utilized, for example, including one at a shooter's position enabling an exemplary ready button and a stop button. Increased functionality may be offered at the shooter's position, up to and including full control over a simulation. An additional control panel or control module may be provided, either at a localized rangemaster's station or remotely through a remote server device available through a wireless communications network. For example, the company that rents or sells the disclosed system may further provide a service to operate and control simulations through the remote server device. Alternatively, a local rangemaster may be given a range of options through a touch screen device, for example, operating one of a plurality of selectable simulations and/or manually controlling operation of a plurality of car devices upon a plurality of metal tracks.

Metal tracks or metal rails may be straight, enabling one to move a car device and corresponding target linearly away from and toward a user/shooter. Metal tracks or metal rails may run perpendicular to a view of the user/shooter, enabling a car device and corresponding target to move across a user's field of view. Metal tracks or metal rails may be curved and/or include junctions to enable more complex movement of the car device and corresponding target. For the purpose of the disclosure, metal tracks and metal rails are substantially equivalent structures useful for enabling suspension and movement of the car device.

Other or optional features of the disclosed system may include as follows. The system may include 360 target turning capability for friend/foe target facings and edge facings to hide the target from the user. The system may include target courses to allow pre-programmed (and random) series of target distances, timings, and friend/foe facings (turning the target). The system may include projected content and with shot detection to provide dynamic 2D, 3D, and video targetry with interactive targets and real-time scoring. The system may include auto-scoring on standard paper targets. The system may include additional controls and capabilities for lights/sounds/distractions at the target (pre-programmed and on-demand). The system may include video/audio capture of shooter during each exercise of string of fire, which may be available for immediate export to a memory stick, local storage, and/or upload to remote server system. The system may include a sub-system to push shooter results to master control station and/or an online portal, to allow generating reports, status, social media posts, etc. The system may be fully controllable via master control wireless and fixed mount stations.

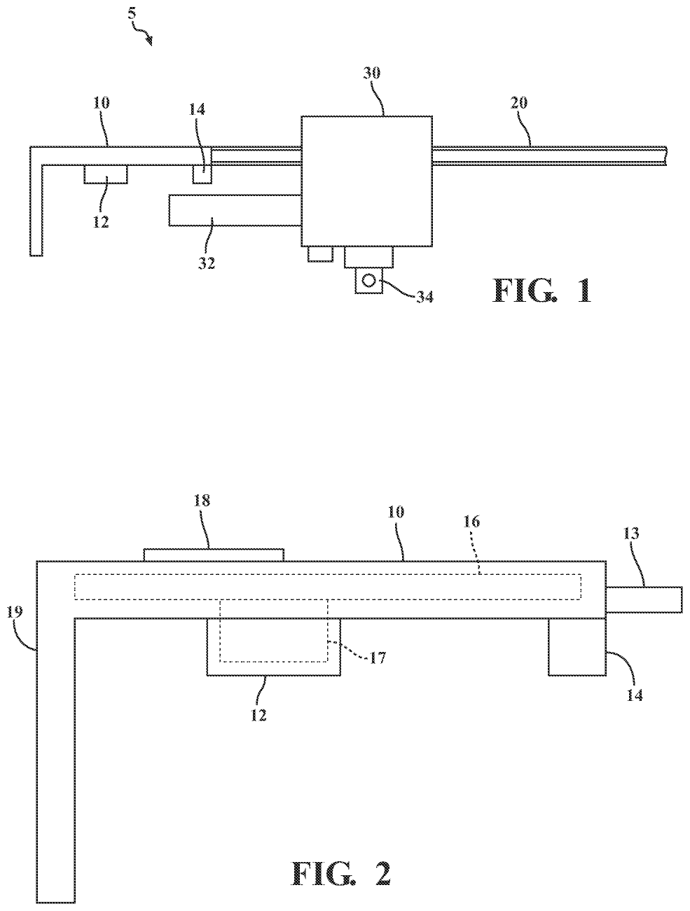

Referring now to the drawings, wherein like reference numbers refer to like features throughout the several views, FIG. 1 schematically illustrates an exemplary system 5 for a smart rail target. The system 5 includes a lane controller charging station 10, a metal track 20, and a car device 30. The lane controller charging station 10 may be configured for being mounted above a shooter's station in a gun range. The lane controller charging station 10 may include a charging transmitter 12 and a mechanical stop 14. The charging transmitter 12 includes a first wire coil configured for generating a magnetic field. In one example, the charging transmitter may operate at 24 Volts and provide 100 Watts of charging power. The mechanical stop 14 includes a geometric feature or face that engages with a mating portion upon the car device 30, such that when the car device 30 stops against the mechanical stop 14, the car device 30 is disposed in a position to be charged.

The metal track 20 may include a variety of shapes and cross-sectional properties. The metal track 20 is configured for enabling the car device 30 to travel along the metal track 20 without obstruction.

The car device 30 includes a recharging portion 32 which, when the car device 30 is moved to abut or reaches a parked state next to the lane controller charging station 10, is situated or disposed next to the charging transmitter 12, such that a magnetic field created by the charging transmitter 12 is useful to generate electrical current within a charging receiver of the recharging portion 32. The car device 30 further includes a mounting feature 34 useful to mount a target to the car device 30. The mounting feature 34 may include an ability to turn an attached target.

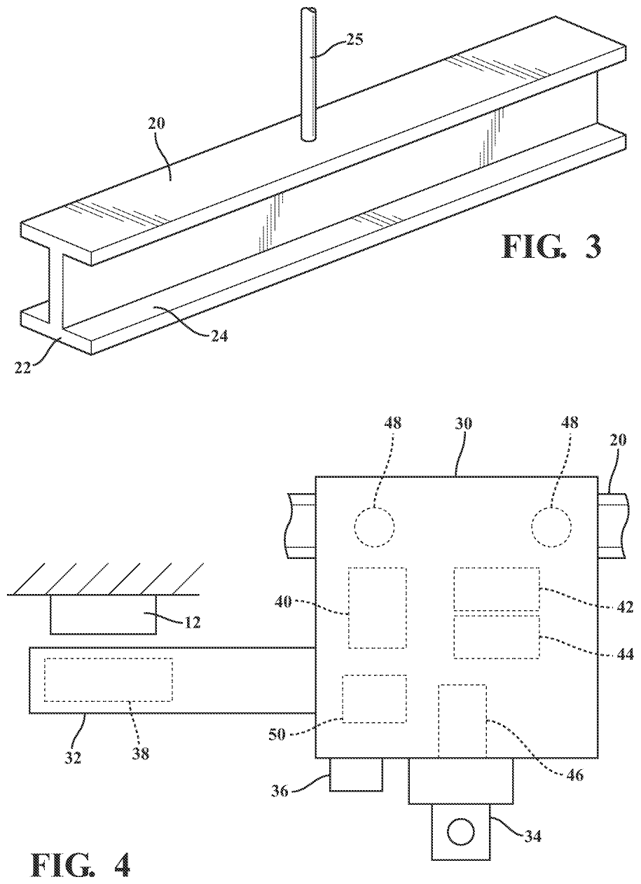

FIG. 2 schematically illustrates the lane controller charging station 10 of FIG. 1. The lane controller charging station 10 includes the charging transmitter 12 and the mechanical stop 14. The lane controller charging station 10 further includes a circuit board 16, a charging transmitter coil 17, a cooling fan 18, a lane indicator facia 19, and a metal track connection feature 13. The circuit board 16 may be a printed circuit board including programmed code operable to selectively provide current to the charging transmitter 12. The circuit board 16 may include a proximity switch or a similar sensor to detect when a car device 30 of FIG. 1 is in position such that the charging transmitter 12 may be activated only when the car device 30 is present. The circuit board 16 may have wireless communication access, such that commands from a remote device may be processed and executed. The circuit board 16 may be replaced by a computerized controller including a processor, random access memory (RAM), and a durable storage medium such as a hard drive.

The charging transmitter coil 17 may be a cylindrically shaped coil of copper wire or similar wire. The cooling fan 18 is configured for circulating air through the lane controller charging station 10 such that the electronic equipment therewithin remains at acceptable temperatures. The lane indicator facia 19 may be backlit or may be a display panel and may display a lane number, a user's name, or other information. In one embodiment, a color of the lane indicator facia 19 may be electronically selectable. The metal track connection feature 13 is configured for attachment to metal track 20 of FIG. 1 and aids in the alignment of the metal track to the lane controller charging station 10.

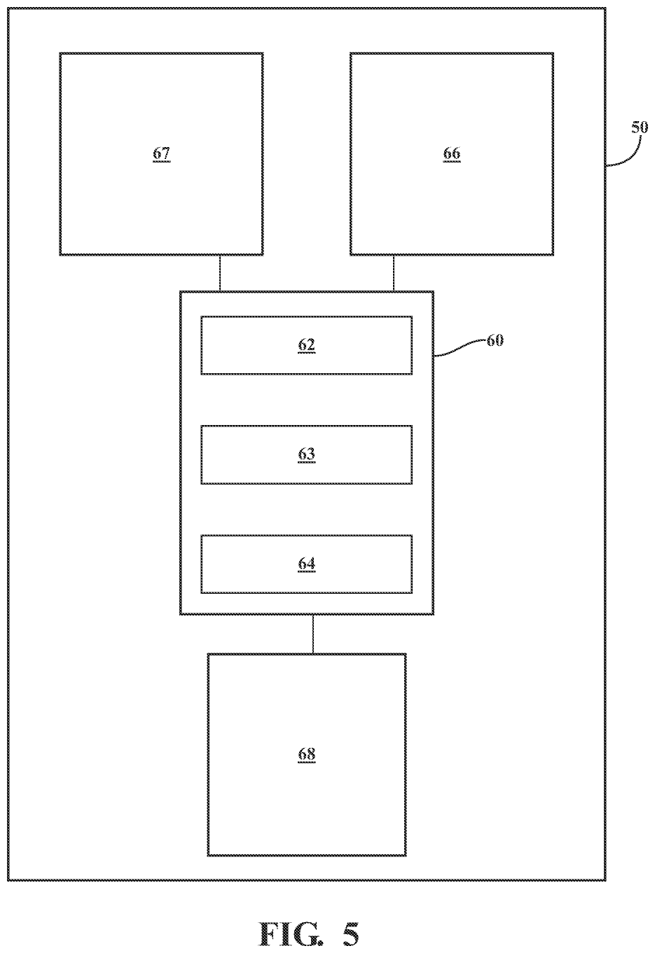

FIG. 3 schematically illustrates a portion of the metal track 20 of FIG. 1. The metal track 20 of FIG. 1 may be relatively long, for example, 25 yards in length. The portion of the metal track 20 illustrated in FIG. 3 provides illustration of an exemplary I-beam cross section 22 which may be utilized with the metal track 20. Other cross-sectional shapes may alternatively be utilized. Further, a beam surface 24 which may be utilized by traction wheels of the car device 30 of FIG. 1 is illustrated. Additionally, mounting bar 25 illustrates an exemplary feature that might be used to suspend the metal track 20 from a facility ceiling or an overhead support structure.

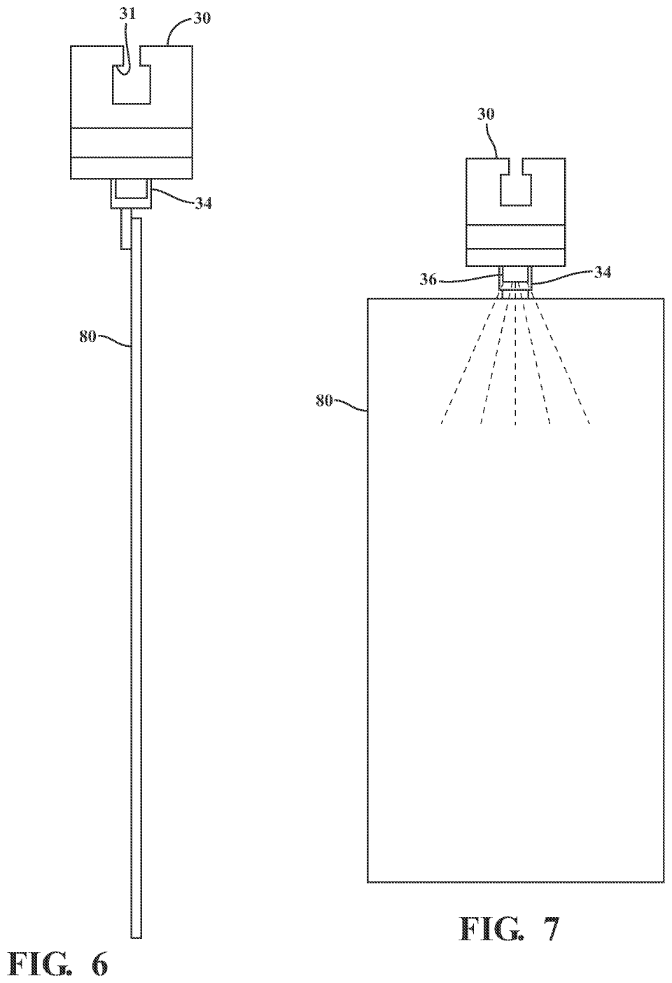

FIG. 4 schematically illustrates the car device of FIG. 1 in side view. The car device 30 includes the recharging portion 32 and the mounting feature 34. The recharging portion 32 includes a charging receiver coil 38 which may include a cylindrically-shaped coil or copper wire or similar wire and is configured for generating an electrical current based upon a magnetic field generated by the charging transmitter 12. Current from the charging receiver coil 38 is provided to an energy storage device 40 which may include one or more rechargeable batteries. One or more electric motors 42 and 44 may be provided to provide motive force to the car device 30. A plurality of traction wheels 48 are provided which may engage with a surface upon the metal track 20. In one embodiment, the electric motor 42 may drive two traction wheels 48 on one side of the car device 30, and the electric motor 44 may drive two traction wheels 48 on a second side of the car device 30. A rotating motor 46 is illustrated connected to the mounting feature 34, such that the mounting feature 34 or details thereof may be selectively turned, thereby turning an attached target. An auxiliary device 36 is illustrated attached to the car device 30. The auxiliary device 36 may include a light projector, a camera device, a laser pointer device, a speaker, a microphone, and/or other similar devices. More than one auxiliary device 36 may be present upon the car device 30.

A computerized car device controller 50 is illustrated within the car device 30 of FIG. 4. The computerized car device controller 50 may be replaced by a circuit board or other similar device capable of executing stored programming.

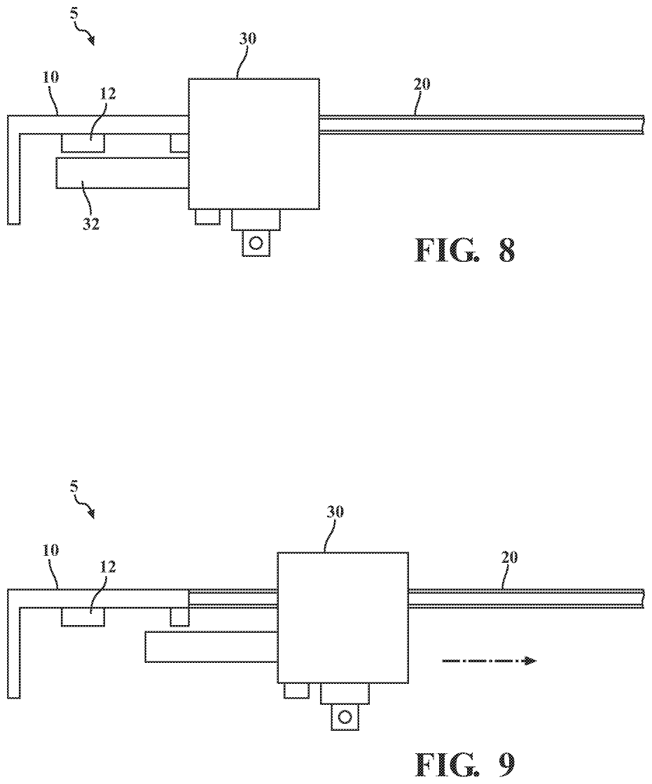

FIG. 5 schematically illustrates the computerized car device controller 50 of FIG. 4. The computerized car device controller 50 may include a processing device 60, a communications module 66, an input/output module 67, and a memory storage device 68.

The processing device 60 may include a processor capable of executing stored code and may operate a operating system. The processing device 60 may include RAM. The processing device 60 is illustrated including three exemplary computational modules 62, 63, and 64, representing computerized functions that the processing device 60 is capable of executing. The computational module 62 is a battery management module, with code configured for monitoring and making decisions about a state of charge and optionally a state of health of the energy storage device 40 of FIG. 4. The computational module 63 is a charging operation management module, which includes code configured for managing charging of the energy storage device 40 of FIG. 4, for example, by issuing commands to the lane controller charging station 10 of FIG. 1. The computational module 64 is a target operation module, with code configured for receiving and executing commands related to display and operation of a targeting simulation. The computational module 64 may issue commands the electric motors 42 and 44 to move car device 30 of FIG. 4, may issue commands to the rotating motor 46 to control rotation of a corresponding target, and may issue commands to one or more auxiliary devices 36 to provide lighting, sounds, or other operations related to running a simulation.

The communications module 66 includes hardware and/or software useful for providing wireless communication of the computerized car device controller 50 with remote computerized panels, the lane controller charging station 10, and/or a remote server device.

The input/output module 67 includes hardware and/or software useful for receiving data from different portions of the car device 30 of FIG. 4 and controlling different devices and portion of the car device of FIG. 4.

The memory storage device 68 stores programming for use by the processing device 60. A number of variations of the computerized car device controller 50 are envisioned, and the disclosure is not intended to be limited to the examples provided herein.

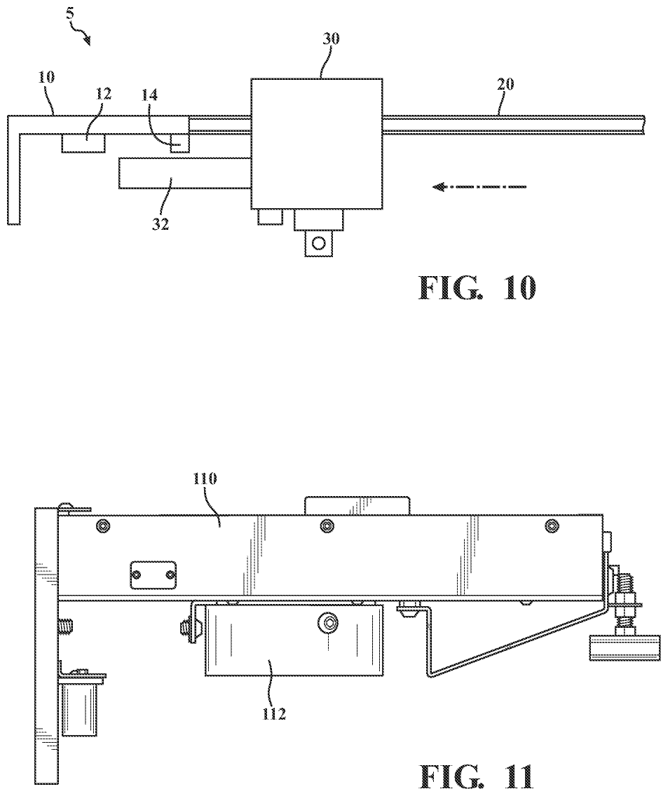

FIG. 6 schematically illustrates the car device 30 of FIG. 1 in front view, with a target 80 attached to the car device 30. The car device 30 is illustrated including a channel feature 31 configured for receiving the metal track 20 of FIG. 1. The mounting feature 34 is illustrated, controlling a rotation of the target 80. In the embodiment of FIG. 6, where a front of the car device 30 is oriented to face a user/shooter, the target 80 is turned to a side such that a face of the target 80 is not pointed toward the user/shooter.

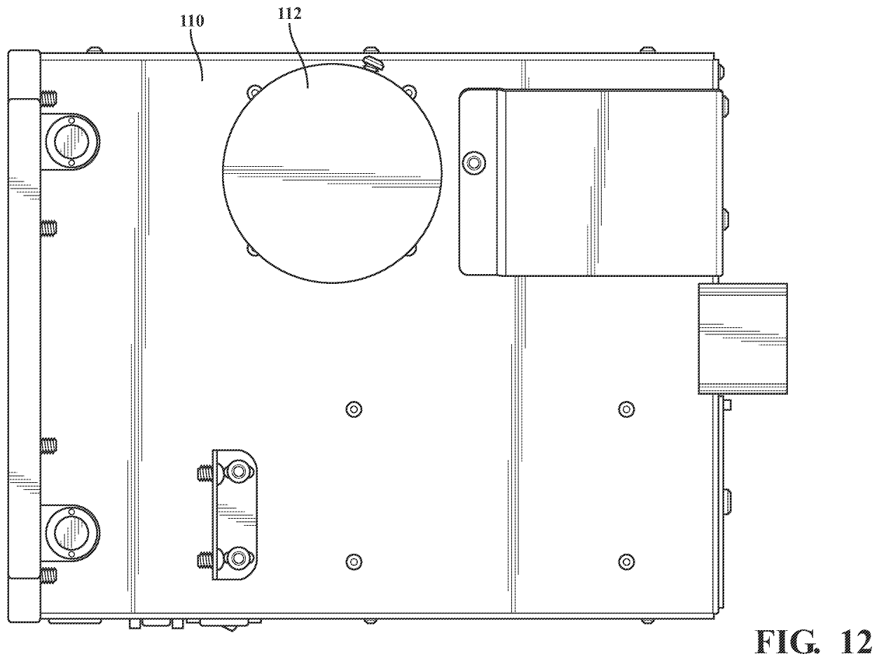

FIG. 7 schematically illustrates the car device 30 of FIG. 6 in front view, with the target 80 turned to face a user/shooter. The mounting feature 34 is selectively controlled to turn the target 80 toward the user/shooter. An auxiliary device 36 embodied as a spotlight is utilized to train an illuminating beam of light upon the target 80.

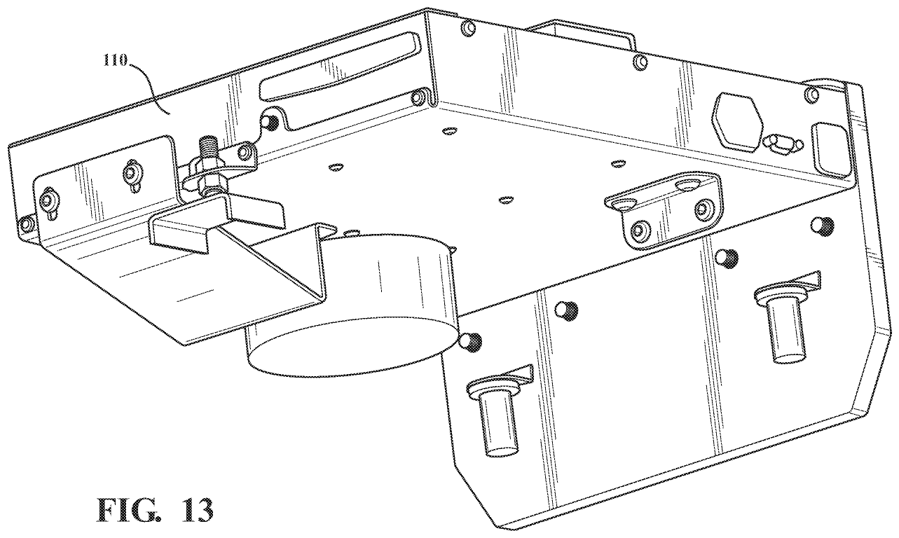

FIGS. 8-10 schematically illustrate the system 5 of FIG. 1 in a docked state, a traveling downrange state, and a returning to be charged state, respectively. The system 5 includes the lane controller charging station 10 including the charging transmitter 12. The system 5 further includes the metal track 20. The system 5 further includes the car device 30 including the charging portion 32. In FIG. 10, the car device 30 may travel until it butts against the mechanical stop 14 of the lane controller charging station 10. The motors of the car device 30 may continue to push the car device 30 until a fully seated condition against the mechanical stop 14 is confirmed to ensure a proper position of the charging portion 32 in relation to the charging transmitter 12. In one embodiment, a current draw of the motors of the car device 30 may be used to diagnose when the car device 30 is seated against the mechanical stop 14, with a sharp increase in the current draw indicating that the car device 30 has moved as far as it can.

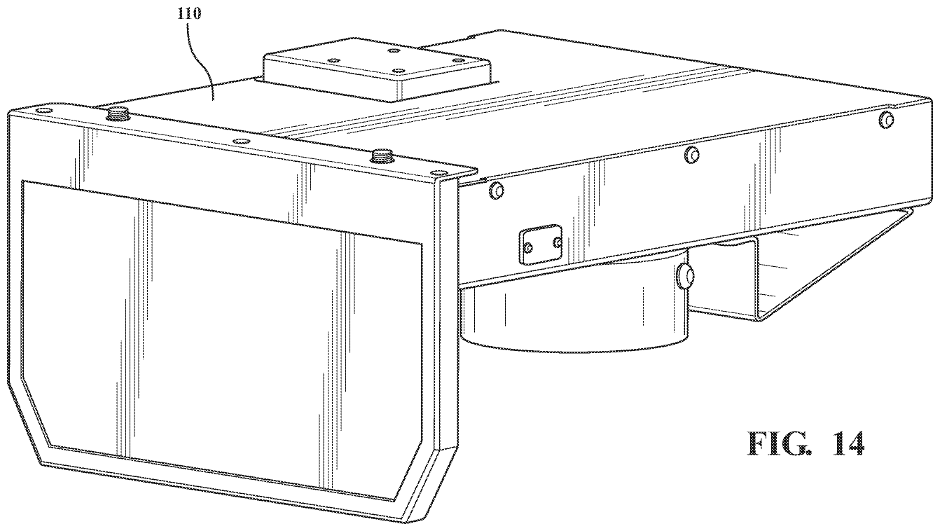

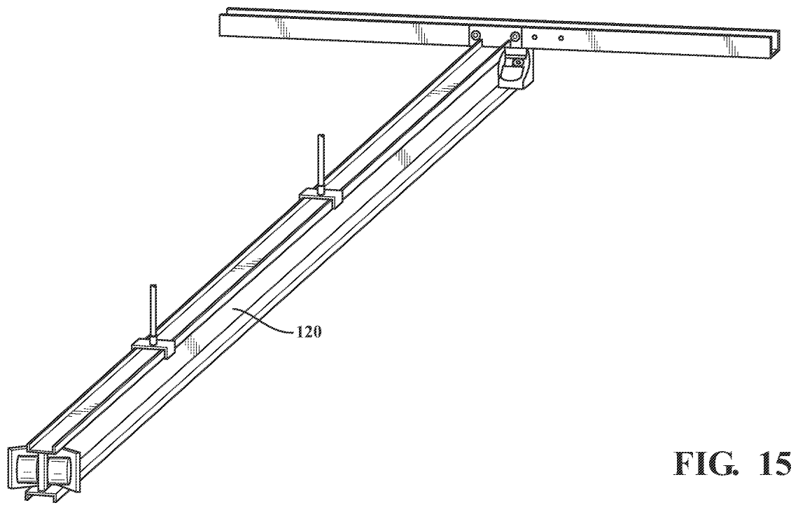

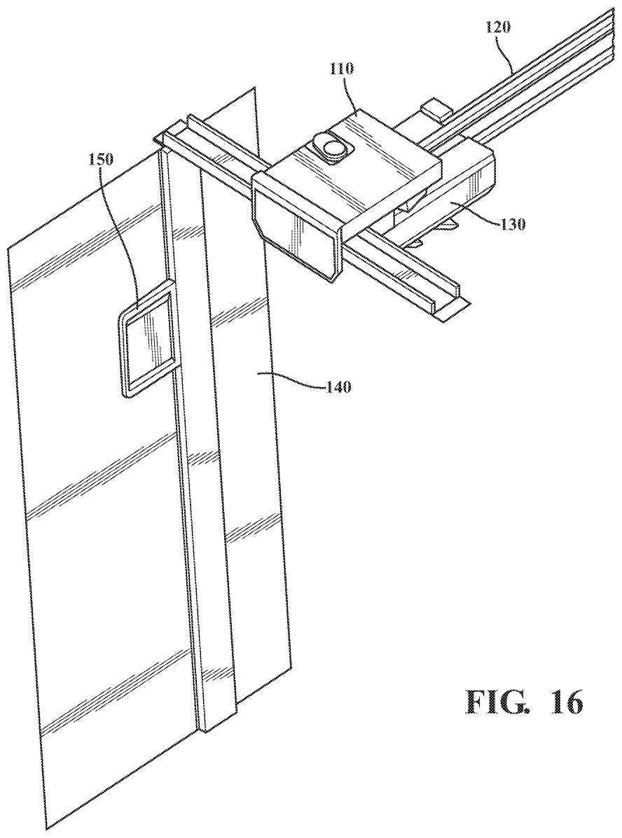

FIGS. 11-14 schematically illustrate one exemplary alternative embodiment of a lane controller charging station 110 including a charging transmitter 112. FIG. 15 schematically illustrates a portion of a metal track 120. FIG. 16 schematically illustrates a shooting stall 140, including the lane controller charging station 110, the metal rail 120, a car device 130, and a computerized control panel 150. The computerized control panel 150 may be a dedicated electronic controller or may be a portable computerized device with a downloaded software application useful to provide control to the illustrated system. In one embodiment, the computerized control panel 150 may include a display screen providing integrated video real time shot feedback. As described in relation to FIG. 4, the car device 30 may include an auxiliary device 36 including a camera device. Images from the auxiliary device 36 may be provided to the computerized control panel 150, and the user may be provided with real time shot feedback, illustrating where a most recent shot registered upon the target. This real time shot feedback enables the user to see their shot without having to run the car device 30 back home to review shots then send back out to resume shooting.

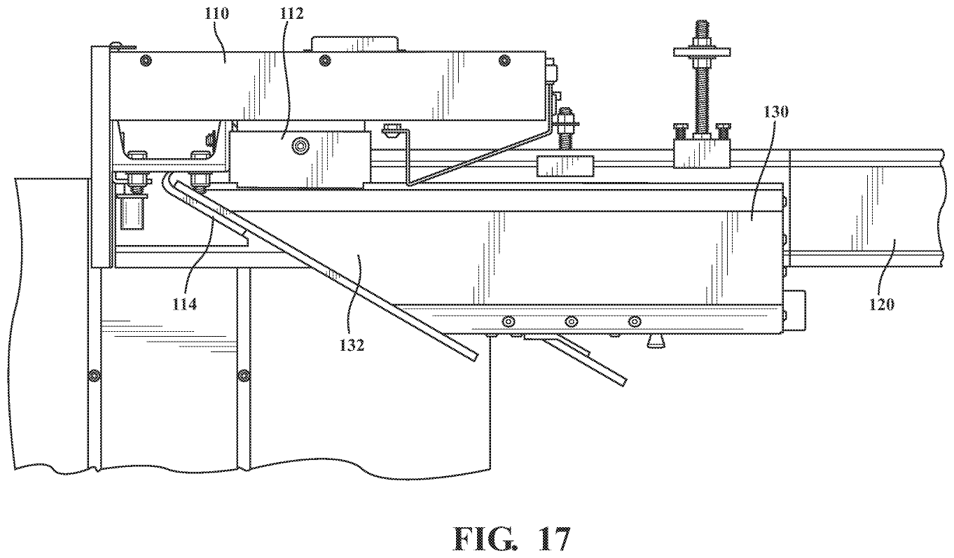

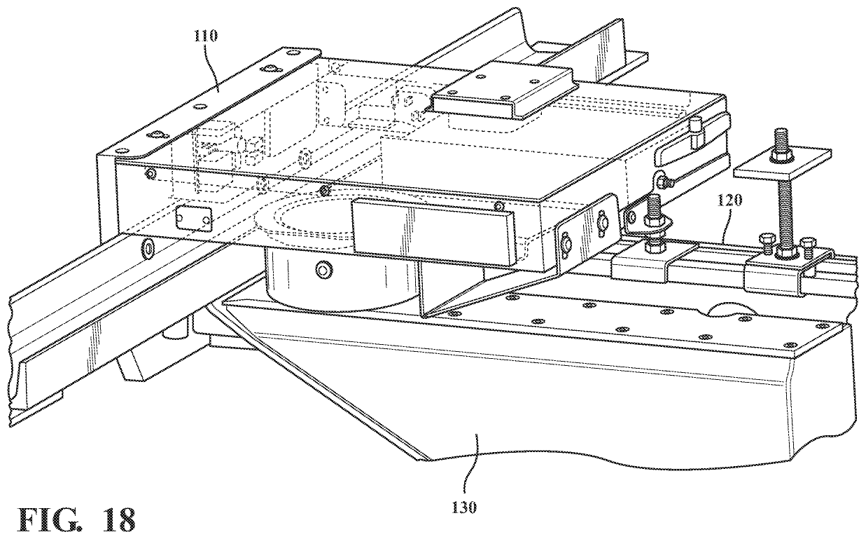

FIG. 17 schematically illustrates the car device 130 upon the metal track 120 abutting the lane controller charging station 110, with charging portion 132 located within a charging distance of a charging transmitter 112. A mechanical stop 114 is illustrated useful to stop the car device 130 in an appropriate location to charge. FIG. 18 schematically illustrates in cutaway perspective view the car device 130 upon the metal track 120 abutting the lane controller charging station 110.

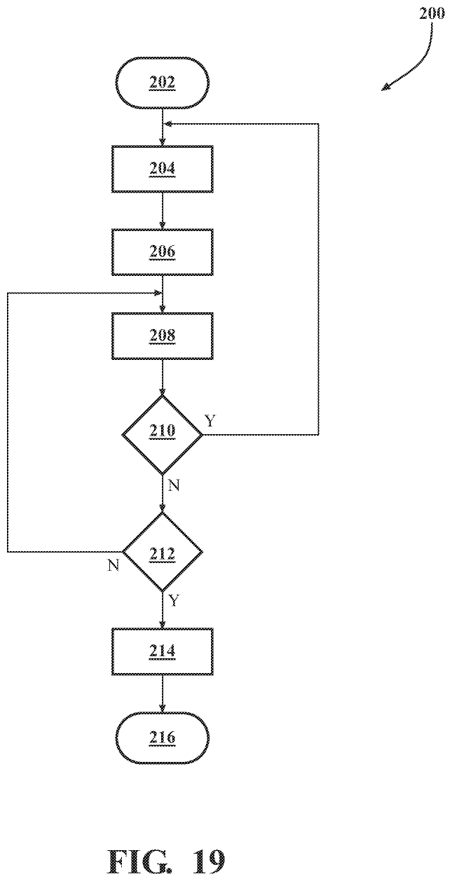

FIG. 19 is a flowchart illustrating a method 200 for a smart rail target. The method 200 starts at step 202. At step 204, a car device located on a metal track is moved in position to abut a lane controller charging station and thereby move a charging portion of the car device next to a charging transmitter of the lane controller charging station. At step 206, one or more batteries of the car device are charged. At step 208, the car device is utilized to operate a targeting simulation, for example, moving downrange, selectively turning a target to face a user/shooter, and utilize a camera device to automatically score hits upon the target. At step 210, a determination is made whether the batteries of the car device are depleted enough to justify recharging. If the batteries are not to be recharged, the method 200 returns to step 204 where the car device is moved into position to be recharged. If the batteries are to be recharged, a determination is made at step 212 whether the simulation is complete. If the simulation is not complete, the method 200 returns to step 208 where the car device continues to be utilized to operate the targeting simulation. If the simulation is complete, the method 200 advances to step 214, where the car device is returned to the lane controller charging station for recharging, and the simulation is ended. At step 216, the method 200 ends. A number of alternative and/or additional method steps are envisioned, and the disclosure is not intended to be limited to the particular examples provided herein.

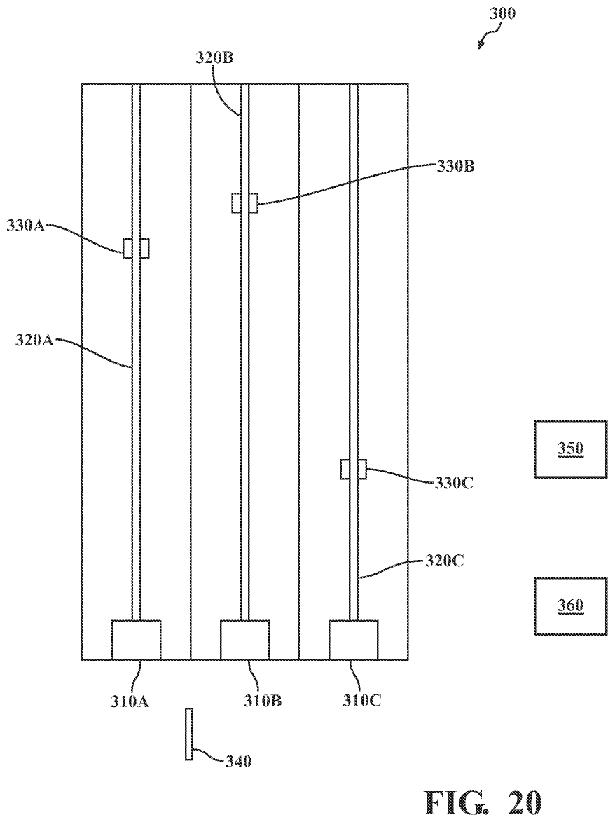

FIG. 20 schematically illustrates an exemplary gun range 300 including a first lane controller charging station 310A, a second lane controller charging station 310B, and a third lane controller charging station 310C. Metal rails 320A, 320B, and 320C are illustrated. Car devices 330A, 330B, and 330C are illustrated. Control panel 340 is illustrated positioned at a user/shooter station. Computerized rangemaster controller 350 is illustrated providing wireless control over the gun range 300 to a local rangemaster. Remote server device 360 provides computerized support to the gun range 300, for example, providing a catalog of candidate computerized range simulations to be operated.

The computerized rangemaster controller 350 may be utilized to provide control over some portion of operations performed within the gun range 300. For example, the computerized rangemaster controller 350 may be described as a master control system. The master control system may allow for a single instructor to operate up to fifty lanes of targets and/or lanes. The master controller may receive inputs from and provide outputs to a remote wireless tablet, a wireless cellular device, and/or a computerized desktop station within a remote control room. The master controller may allow a single instructor to execute a complete course of fire for up to fifty shooters from a single point location or command.

The computerized rangemaster controller 350 may operate programming to enable shot scoring to provide instant feedback showing shot placement. The computerized rangemaster control may count or score areas and shots based upon shot placement to calculate an automatic result total. Shot scoring may be accomplished via software integrated with either thermal (heat signature/friction) shot detection overlayed onto a simulated shooting plain with shot areas and values pre identified in the software.

The computerized rangemaster controller 350 may further provide a virtual instructor feature. In one embodiment, visual text and audible voice instructing through specified courses of fire. This feature may mimic a live instructor, providing recorded lessons and guidelines, without a live person or instructor being present.

While the best modes for carrying out the disclosure have been described in detail, those familiar with the art to which this disclosure relates will recognize various alternative designs and embodiments for practicing the disclosure within the scope of the appended claims.

What is claimed is:

1. A system for a smart rail target, the system comprising:
a metal rail;
a car device configured for being mounted to and moving along the metal rail, the car device including:
a plurality of traction wheels configured for moving the car device along the metal rail;
an electric motor configured for providing motive force to the traction wheels; and
a rechargeable energy storage device configured for providing electrical energy to the electric motor; and
a lane controller charging station connected to the metal rail and including a charging transmitter configured for charging the rechargeable energy storage device when the car device abuts the lane controller charging station.

2. The system of claim 1, wherein the charging transmitter includes a first metal coil configured for creating a magnetic field; and
wherein the car device includes a charging portion including a second metal coil configured for using the magnetic field to create an electric current useful for recharging the rechargeable energy storage device.

3. The system of claim 1, wherein the lane controller charging station further includes a mechanical stop configured for providing a proper location for the car device to stop to be recharged.

4. The system of claim 1, wherein the car device further includes a mounting feature configured for suspending a shooting range target and controlling rotation of the shooting range target.

5. The system of claim 1, wherein the electric motor includes a first electric motor configured for providing a first motive force to a first portion of the plurality of traction wheels; and
wherein the car device further includes a second electric motor configured for providing a second motive force to a second portion of the plurality of traction wheels.

6. The system of claim 1, wherein the car device further includes a computerized car device controller controlling operation of the car device.

7. The system of claim 6, wherein the computerized car device controller is in wireless communication with the lane controller charging station.

8. The system of claim 6, further comprising a computerized rangemaster controller in wireless communication with the computerized car device controller and providing computerized control to a local rangemaster.

9. The system of claim 6, further comprising a remote computerized server device in wireless communication with the computerized car device controller and providing access to a plurality of computerized range simulations.

10. The system of claim 1, wherein the lane controller charging station further includes a lane indicator facia including one of a backlit lane indication, a backlight with a selectable color, or a computerized display.

11. A system for a smart rail target, the system comprising:
a metal rail;
a car device configured for being mounted to and moving along the metal rail, the car device including:
a plurality of traction wheels configured for moving the car device along the metal rail;
an electric motor configured for providing motive force to the traction wheels;
a rechargeable energy storage device configured for providing electrical energy to the electric motor;
a mounting feature configured for suspending a shooting range target and controlling rotation of the shooting range target; and
a computerized car device controller controlling operation of the car device;
a lane controller charging station connected to the metal rail and including a charging transmitter configured for charging the rechargeable energy storage device when the car device abuts the lane controller charging station;
a shooting stall configured for a user to occupy during operation a computerized range simulation; and
a computerized control panel disposed upon the shooting stall and configured for enabling the user to control the operation of the computerized range simulation.

12. The system of claim 11, wherein the charging transmitter includes a first metal coil configured for creating a magnetic field; and
wherein the car device includes a charging portion including a second metal coil configured for using the magnetic field to create an electric current useful for recharging the rechargeable energy storage device.

13. The system of claim 11 wherein the computerized car device controller is in wireless communication with the lane controller charging station.

14. The system of claim 13, further comprising a computerized rangemaster controller in wireless communication with the computerized car device controller and providing computerized control to a local rangemaster.

15. The system of claim 14, wherein the computerized rangemaster controller includes programming to provide shot scoring to the user.

16. The system of claim 14, wherein the computerized rangemaster controller includes programming to provide a virtual instructor feature to the user.

17. The system of claim 14, further comprising a remote computerized server device in wireless communication with the computerized car device controller and providing access to a plurality of candidate computerized range simulations.

18. A method for a smart rail target, the method comprising:
within a lane of a gun range, suspending a metal rail;
mounting a car device to the metal rail, wherein the car device includes a rechargeable energy storage device and is configured for moving forward or backward along the metal rail and is further configured for suspending a shooting range target;
mounting a lane controller charging station to a first end of the metal rail, wherein the lane controller charging station includes a charging transmitter configured for wirelessly charging the car device; and
when the rechargeable energy storage device has a low state of charge, moving the car device to the first end of the metal rail and wirelessly charging the car device.

19. The method of claim 18, further comprising, within a computerized processor, operating a computerized range simulation configured for selectively controlling the car device.

20. The method of claim 19, wherein selectively controlling the car device includes controlling movement of the car device along the metal rail and controlling rotation of the shooting range target.
